(19) United States
(12) Patent Application Publication
(10) Pub. No.: US 2005/0276952 A1
(43) Pub. Date: Dec. 15, 2005

(54) Blind fabric

(76) Inventor: Reginald Charles Allsopp, Stockport (GB)

Correspondence Address: Mark J. Burns;Haugen Law Firm PLLP, Suite 1130, 121 South Eighth Street, Minneapolis, MN, 55402, US

(21) Appl. No.: 11/147,616

(22) Filed: Jun. 8, 2005

(30) Foreign Application Priority Data
Jun. 11, 2004 (GB) 0413003.5

(51) Int. Cl. B32B 3/00

(52) U.S. Cl. 428/188

(57) ABSTRACT

A Roman blind fabric and a Roman blind made from the fabric. The Roman blind fabric comprising a non-woven web of continuous filaments or microfilaments, the web having a weight in the range 5 g/m²-600 g/m² and being formed from composite filaments. The fabric includes a plurality of elongate widthwise channels adapted to receive therein respective scaffold elements.

### FIELD OF THE INVENTION

The present invention relates to a Roman blind fabric. In addition, the present invention relates to a Roman blind fabric comprising a non-woven web which provides the advantages of conventional blind fabrics in addition to an enhanced aesthetic appearance and tactile properties. Further the present invention relates to a Roman blind made from the Roman blind fabric of the invention.

### BACKGROUND OF THE INVENTION

The term ‘window’ is used herein as a convenient reference with the understanding that the invention may also be used as a covering for doors or other architectural openings.

Fabrics conventionally used in window coverings may be coated on at least one of their front and rear surfaces using a resin binder such that they are heat and light resistant, that they don't warp or cup and that they may be cut without the material fraying. However, this treatment results in a stiff dull fabric which does not drape well and has poor tactile properties. The non-woven web used in the present invention attempts to overcome or ameliorate at least some of these problems. It displays each of the properties afforded by presently available blind fabrics in addition to providing a comparatively soft, tactile fabric with low stiffness, excellent draping properties and crease resistance. In addition, the non-woven web has an aesthetically pleasing dimpled appearance.

Further, the non-woven web used in the present invention has a density sufficient to provide handle, yet is sufficiently pliable to enable the formation of soft pleats when the blind is raised. The fabric is also stretch and shrinkage resistant and sufficiently strong to undergo the manufacture, storage and transport of the blinds prior to installation. A further advantage of the fabric used in the invention is that it is fray resistant when cold cut, and when stitched, removing the need for additional chemical treatment to prevent this degradation of the fabric.

### SUMMARY OF THE INVENTION

According to a first aspect of the present invention there is provided a Roman blind fabric, comprising a plurality of widthwise channels adapted to receive therein scaffold elements, such that it facilitates the assembly of a Roman type blind by a non-skilled person.

The Roman blind fabric comprises a non-woven web of continuous filaments or microfilaments which may be crimped or not, and are obtained by means of a controlled direct spinning process. They have a weight in the range 5 g/m²-600 g/m² and are formed, after napping, of separable composite filaments. Preferably, the non-woven web will have a weight in the range 100-400 g/m², more preferably in the range 130-220 g/m², most preferably in the range 150-190 g/m². Non-woven webs of this type are described more fully in EP 0 814 188 B1, in the name of Carl Freudenberg K G. The contents of this document, especially as they relate to the specific properties of the fabric and manufacture are specifically incorporated herein by reference. Preferably, the non-woven web used in the Roman blind fabric will be the Evolon™ fabric sold by Carl Freudenberg K G.

The Evolon™ fabric is produced from composite filaments, which are separated during manufacture to provide very thin filaments or micro-fibres of continuous length. The thin filaments provide the drape ability characteristics of the fabric, whilst the continuous length of the filaments leads to a fabric of low stiffness. There is a high density of filaments per fabric area which results in a fabric with a good tensile strength.

Preferably, the composite filaments have a filament number between 0.3 dTex and 10 dTex, and are each formed of at least three elementary filaments of at least two different materials, comprising among them at least a plane of separation or cleavage, each elementary filament having a filament number between 0.005 dTex and 2 dTex, with the ratio of the cross-sectional area of each elementary filament to the total cross-sectional area of the unitary filament being between 0.5% and 90%. Preferentially, the composite filaments have a filament number greater than 0.5 dTex, and each elementary filament has a filament number less than 0.5 dTex. More preferentially, the composite filaments have a filament number between 0.6 dTex and 3 dTex, and the elementary filaments have a filament number between 0.02 dTex and 0.5 dTex.

On the basis of the number of elementary filaments, the web obtained can be designated as being a non-woven web of continuous microfilaments. Preferentially, the non-woven web is, following the controlled operations of extrusion/spinning, drawing/cooling, and napping, subjected simultaneously or successively to bonding and consolidation operations by mechanical means. These may be intense needle punching, the action of pressurized streams of fluid, ultrasound and/or mechanical friction, thermal means, such as boiling water, steam, or microwaves, or chemical means, such as treatment by swelling chemical agents acting upon at least one of the materials constituting the composite filaments. This causes the composite filaments to at least partially separate into their elementary filaments during the course of the operations of bonding and consolidation.

The method of manufacture limits the directional nature of the fibrous structure, which in combination with the filament density provides a soft fabric which may be cold cut without fraying. The non-woven web may be dyed, printed or otherwise coloured and may be embossed as necessary for the particular application.

The different polymer materials forming the composite filaments are distributed into distinct zones when the latter are viewed in cross-section, in such a way as to permit their separation into elementary filaments, each corresponding, when viewed in cross-section, to one of the zones.

To permit easy separation of the composite filaments into elementary filaments, while enabling direct initial contact between the elementary filaments to form the composite filaments, the different polymer materials constituting the composite filaments are preferentially immiscible and/or incompatible among themselves because of their nature or following treatment of at least one of the polymer materials.

It is preferred that the group of polymer materials forming the elementary filaments is selected from among the following groups:
(polyester/polyamide),
(polyamide/polyolefin),
(polyester/polyolefin),
(polyurethane/polyolefin),
(polyester/polyester modified by at least one additive),
(polyamide/polyamide modified by an additive),
(polyester/polyurethane),
(polyamide/polyurethane),
(polyester/polyamide/polyolefin),
(polyester/polyester modified by at least one additive/polyamide),
(polyester/polyurethane/polyolefin/polyamide).

It is more preferred that the polymer materials are selected from polyesters, polyamides and/or polyolefins. Preferably, the polymer material is a combination of polyesters and polyamides. More preferably the polyester will be polyethylene terephthalate (PET) or polybutylene terephthalate (PBT). Typically, the polyamide will be Nylon™.

One possible substrate for the non-woven web is composite filaments which have, in cross-section, a configuration of the zones representing the cross-sections of the different elementary filaments in the form of wedges or triangular sections.

The wedges or sections, which form the cross-sectional pattern of the composite elements, may have different dimensions, thus generating, after disconnection and separation of the initial composite filaments, elementary filaments of clearly different filament numbers.

To promote separation of the composite elements into elementary filaments, the composite filaments may contain a hollow longitudinal tubular cavity, centred or not with respect to the median axis of the composite filaments. In effect, this arrangement can be used to eliminate close contact between the edges of the elementary filaments formed by the inside angles of the wedges or sections before separation of the composite filaments and contact between different elementary filaments made of the same polymer material.

A second possible substrate for the non-woven web comprises elementary filaments which are integrated in a surrounding matrix of a material that is easily separable or dissolvable, the material of the matrix also being present in the interstices separating the elementary filaments or replaced by another polymer material that is dissolvable or incompatible with the polymer material forming the elementary filaments. In this case the outlines of the cross-sections of the elementary filaments can be irregular and notably appear as wedges or sections, the surrounding matrix forming the receiving compartments of the wedges or sections along with an external envelope surrounding all of the wedges or sections.

In a third possible substrate, the outside contours of the cross-sections of the composite filaments present a multi-lobe configuration, defining several sectors or zones, each corresponding to an elementary filament

To further consolidate the structure of the non-woven web, the composite filaments may present a latent or spontaneous crimp resulting from an asymmetry in the behaviour of the filaments with respect to their median longitudinal axis, the crimp being activated or accentuated, where appropriate, by an asymmetry in the geometry of the configuration of the cross-section of the composite filaments.

In a variant, the composite filaments may present a latent or spontaneous crimp resulting from a differentiation of the physical properties of the polymer materials forming the elementary filaments during the operations of spinning, cooling and/or drawing of the composite filaments, resulting in distortions generated by the asymmetric internal constraints along the longitudinal median axis of the composite filaments, the crimp being activated or accentuated, where appropriate, by an asymmetry in the geometry of the cross-sectional configuration of the composite filaments.

The composite filaments may present a latent crimp that is activated by thermal, mechanical, or chemical treatment prior to formation of the non-woven web. The crimp can be accentuated by an additional treatment of the web, consolidated or not, that is, either thermal (tunnel oven, boiling water, steam, hot cylinder, microwaves, infrared) or chemical, with the possible controlled shrinkage of the web.

To further consolidate the non-woven web, the elementary filaments can first be heavily entangled, during or following the division of composite filaments, by mechanical means (needle punching, pressurized streams of fluid) acting principally in a direction perpendicular to the plane of the web.

The initial composite filaments may be obtained, for example, by electrostatic, mechanical and/or pneumatic (a combination of at least two of these types of deflection is possible) deflection, and projection against a conveyor belt, and mechanically entangled by needle punching (on one or two sides with needles and under perforation conditions that are adequate with respect to the required properties of the non-woven web), or by the action of pressurized streams of fluid, charged or not with solid microparticles, possibly after calendering.

The web may be composed of several stacked non-woven layers each layer consisting of filaments from a single die. Alternatively, at least one layer may consist of filaments from at least two distinct dies, the filaments being blended during the drawing phase, before napping. Similarly, at least one of the layers constituting the web may be constituted by means of filaments that differ from those of at least one other of the constituent layers.

The operations of entanglement and separation of the composite filaments into elementary filaments can be realized in a single stage of the process and with a single device, and the more or less complete separation of the elementary filaments can be carried out by means of a supplementary operation more fully directed toward the separation.

The cohesion and mechanical resistance of the non-woven web can also be substantially increased by binding the elementary filaments by thermobonding one or more of them formed of a polymer material with a lower melting point, by calendering with smooth or engraved hot rollers, by passage through a hot-air tunnel oven, by passage over a through-cylinder, and/or by the application of a binding agent contained in a dispersion, solution, or in the form of a powder. Alternatively, consolidation of the web can also be realized, for example, by hot calendering, prior to any separation of the unitary composite filaments into elementary filaments or microfilaments, the separation being effected after consolidation of the web.

Additionally, the structure of the web may also be consolidated by chemical (as described in French patent 2546536 filed in the name of Carl Freudenberg K G) or thermal treatment, resulting in controlled shrinkage of at least part of the elementary filaments, after having, where appropriate, realized the separation of the latter, resulting in shrinkage of the web in the direction of its width and/or in the direction of its length. Moreover, the non-woven web may, after consolidation, be subjected to a binding or dyeing and finishing treatment of a chemical nature, such as anti-pilling, hydrophilic treatment, or antistatic treatment, improvement of its fire resistance and/or modification of its feel or lustre; or a mechanical nature, such as napping, sanforizing, emerizing, or passing it through a tumbler; and/or of a nature that modifies external appearance, such as dyeing or printing.

One form of the non-woven web may comprise continuous filaments obtained by separating the composite continuous filaments. This web would have a weight of 120 g/m² and be formed from uncrimped continuous polyethylene terephthalate/nylon-6 biocomponent filaments. The composite continuous filaments in this example having a filament count of 1.6 dTex and a cross-sectional configuration of an orange segment with a hollow central orifice. The segments may be composed alternately of one of the two aforementioned polymeric materials and in direct contact with the adjacent segments. In this example, each composite filament is formed from six elementary polyethylene terephthalate filaments with a count of 0.15 dTex and six elementary filaments with a count of 0.11 dTex, resulting in a polyethylene terephthalate/nylon-6 weight ratio of 60/40, the elementary filaments being entangled and bonded.

A preferred non-woven web for use in the invention comprises a web of weight 170 g/m² which is formed from continuous polyester/polyamide biocomponent filaments.

Conventional Roman blinds comprise a sheet of fabric material arranged between a top rail (head rail) and a lifting bar. A plurality of vertically spaced horizontal channels adapted to receive respective scaffold elements are secured to or provided as part of the fabric sheet. In addition, one or more arrays of guide means are secured to or provided as part of the fabric sheet, wherein each array of guide means guides a respective lifting cord. The lifting cords are fixed at one end to the lifting bar. This arrangement results in a blind which may be raised or lowered by raising or lowering the lifting cords.

The preferred Roman blind fabric includes a plurality of vertically spaced horizontal channels, wherein vertical and horizontal refer to the in-use configuration of the fabric. Preferably the channels are formed by shaping the non-woven web such that elongate loops are created in the web, which may be secured in position by, for example, stitching, adhesive or heat bonding.

However, the channel-forming elements may be separate fabric elements fixed to the web e.g. by stitching, adhesive or heat bonding, or they may be formed as a polymeric tubular element.

Alternatively, the channel may be formed by a plurality of loops of a thread-like material. In this embodiment the loops may be formed during the construction of the non-woven web or they may be stitched into the web after its construction.

In a further alternative embodiment, the channel may be formed by a plurality of loops of a rigid material, for example, annular elements made from metal, wood or a polymeric material. These may be attached to the non-woven web by stitching or by any other suitable form of attachment.

In a yet further alternative embodiment, the channel may be formed from an elongate channel forming portion of the non-woven web, wherein the channel is formed during the construction of the non-woven web.

The channels preferably extend across the entire width of the fabric. This makes possible the simple addition of the scaffold elements by threading each of these through a respective one of the pre-formed channels. Thus, the Roman blind fabric may be assembled by a person not skilled in the art of blind assembly to produce a Roman blind.

Preferably the channels will be regularly spaced along the vertical axis and of regular diameter. Most preferably the channels will be of an appropriate size to accommodate snugly a scaffold element. It is preferable that the channels be sized to have a diameter in the range 0.1-5.0 cm, preferably in the range 0.5-3.0 cm and most preferably in the range 0.5-2.0 cm.

According to a second aspect of the present invention there is provided a Roman blind comprising a Roman blind fabric according to the first aspect of this invention attached at a first end to a head rail and at a second end to a lifting bar. Each of the channels of the fabric includes a scaffold element located therein. The blind further includes at least one lifting cord extending from the head rail to the lifting bar, the or each lifting cord being guided by a respective array of guide elements secured to the fabric.

The scaffold element is preferably a rigid rod. A person skilled in the art will appreciate that the rod may be formed from wood, plastics such as nylon or polycarbonate, or metal such as extruded aluminium.

The guide element preferably comprises a clip which snap fits around a portion of the scaffold element, thereby trapping a portion of the fabric between the clip and the scaffold element, wherein the clip includes an ‘eye’ portion extending therefrom, the eye being sized to slidably receive therethrough a lifting cord. The clip is preferably C-shaped in cross section. Alternatively the guide element may comprise an eye portion and an attachment portion for attaching the guide element to the fabric. The attachment portion may be a T-shaped portion for attaching the guide element to the fabric. The attachment portion may be a T-shaped portion which passes through the fabric and resists removal of the guide element therefrom, or, alternatively, it includes a screw thread for attachment of the guide element to the scaffold element, thereby trapping the fabric between a part of the guide element and the scaffold element.

In assembly of the preferred blind, the scaffold elements are located in respective pre-formed channels in the Roman blind fabric. One or more vertical arrays of guide elements are secured to the fabric, preferably adjacent to a respective scaffold element, such that each array of guide elements guides a respective lifting cord. The lifting cords are passed through each of the guide elements in their respective arrays and fixed to the lifting bar. This arrangement results in a blind which may be raised or lowered by raising or lowering the lifting cords. Raising the lifting cords raises the lifting bar until it engages a first scaffold element. Both the lifting bar and the first scaffold element are then raised together via continued raising of the lifting cords until the first scaffold element engages a second scaffold element and so on until the blind fabric no longer covers the aperture (i.e. where the lifting bar and each of the scaffold elements are grouped together at the head rail) or until it is in the desired position at which point the blind may be locked in a position by an appropriate lifting cord locking mechanism for example located in the head rail.

When closed, such that the window is covered, each blind panel (i.e. the area of the blind fabric between neighbouring channels) may be planar or soft folded to form a tear drop shape. Soft folding may be achieved by the addition of a flexible connecting tape disposed between the head rail and the lifting bar and attached to the fabric, preferably adjacent to the horizontal channels, such that the unfolding of the blind is constrained by the connecting tape to a pre-defined maximum spacing between neighbouring channels. The connecting tape may be attached to the channels adjacent to some or all of the guide elements. In certain embodiments, the guide elements may be adapted also to attach the connecting tape to the channels of the fabric.

### BRIEF DESCRIPTION OF THE DRAWINGS

FIGS. 1a to 1g are cross-sectional views of the continuous composite filaments used to form the Roman blind fabric of the invention.

FIG. 2 is a view of the Roman blind fabric according to the first aspect of the present invention;

FIG. 3 is a view of the Roman blind according the second aspect of the present invention; and

FIG. 4 is an enlarged view of the guide and scaffold elements of FIG. 3.

### DETAILED DESCRIPTION OF THE PREFERRED EMBODIMENTS

The objects and advantages enumerated above together with other objects, features, and advances represented by the present invention will now be presented in terms of detailed embodiments described with reference to the attached drawing figures which are intended to be representative of various possible configurations of the invention. Other embodiments and aspects of the invention are recognized as being within the grasp of those having ordinary skill in the art.

For the avoidance of doubt it should be noted that in this specification reference to ‘up’ and ‘down’, ‘width’, ‘height’, ‘upper’, ‘lower’, ‘vertical’, ‘horizontal’, ‘front’, ‘back’ and related terms refers to the orientation that the components of the blind adopt when installed for normal use, as they are shown in the figures.

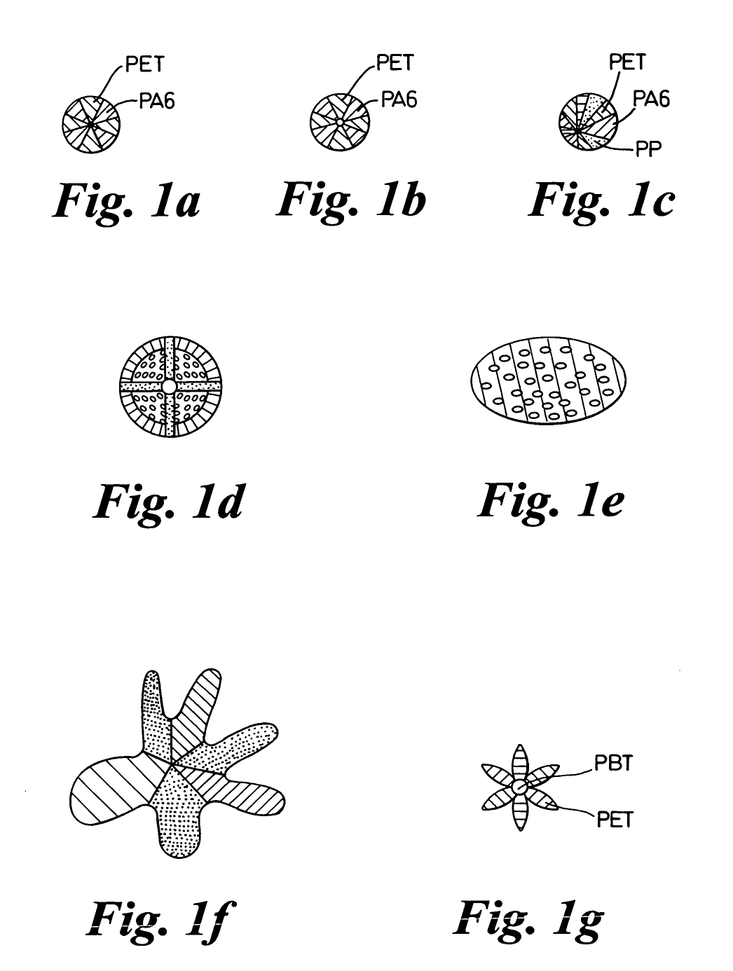

FIGS. 1a-1g represent cross-sections of the continuous composite filaments of the non-woven web, prior to separation into elementary filaments. “PET” is polyethylene terephthalate, “PA6” is polyamide, “PP” is polypropylene and “PBT” is polybutylene terephthalate.

A non-woven web suitable for use in window blinds may be obtained by the methods disclosed in FR 74 20 254. An example of the web used may have a weight of 170 g m² and is prepared by cooling, drawing and napping the filaments as described in FR 74 20 254. After napping the non-woven web is subjected to the action of pressurised streams of water in order to separate the composite filaments into elementary filaments and entangle and bind the latter.

The conditions used are as described in FR 2 705 698 in the name of Carl Freudenberg K G. Specifically, the hydraulic bonding is achieved by successively passing the non-woven web beneath a first wetting-out rack, by squeezing the wet web (by passing it between two calendering rollers or by suction, for example), and finally by passing the web, where it passes the three successive hydraulic binder assemblies, over a suction drum, the assemblies acting respectively on the recto, verso, and recto of the web, and each comprising three strips or lines of jets spaced 0.6 mm apart.

During the process of hydraulic bonding, the non-woven web moves on an 80 mesh metallic screen (80 threads/2.54 cm) with a 70% aperture. The processing speed is in this case approximately 15 m/min. The web is then subjected to consecutive hydraulic bonding, and needle calendering by means of two heated metal rollers, namely an engraved roller at 232° C. and a smooth roller at 215° C. (pressing force: 50 daN/cm of width, speed: 15 m/min, 52 teeth/cm², percentage of surface bound: 13%). On exiting this assembly, the non-woven web is finally wound. This treatment of the web results in an increase of its resistance to deformation and abrasion.

The non-woven web produced by this process has very thin filaments, of continuous length to provide a drapeable fabric of low stiffness. Due to the small diameter of the microfilaments the filament density is high, and the fabric has good tensile strength. In addition, the fabric does not fray when cut and can be readily dyed printed or embossed.

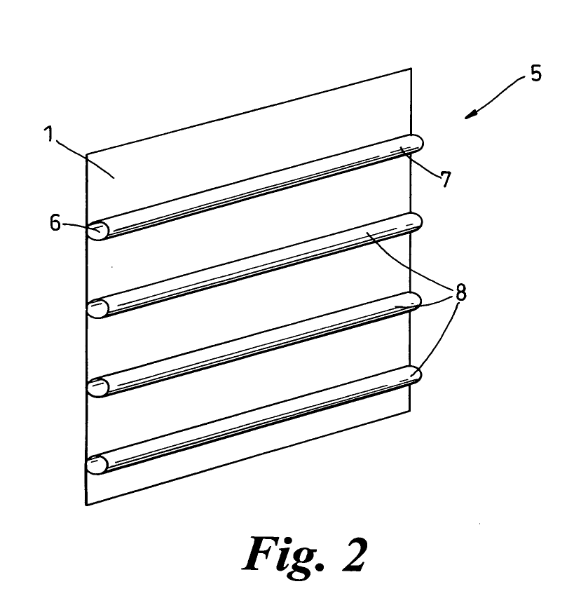

The non-woven web 1 is then further treated to pre-form a “Roman blind fabric” 5 according to the first aspect of the present invention (FIG. 2). Equally spaced horizontal fabric channels 6 are provided on the non-woven web 1 by the formation of elongate loops in the non-woven web 1 such that the internal surface of the loop 7 is the one face of the non-woven web 2 and the external surface of the loop is a second face of the non-woven web 4. The loop 7 is formed such that it extends substantially across the entire width of the non-woven web 1.

The term “front” as used herein is intended to mean the surface of the fabric which in use faces away from the window and the term “rear” as used herein is intended to mean the surface of the fabric which faces towards the window.

The Roman blind fabric 5 is formed by stitching the fabric loop 7 into the non-woven web 1 such that the fabric channel 6 is formed substantially across the entire width of the fabric 5, thereby providing regularly spaced channels 8 into which respective scaffold elements 9 may be located.

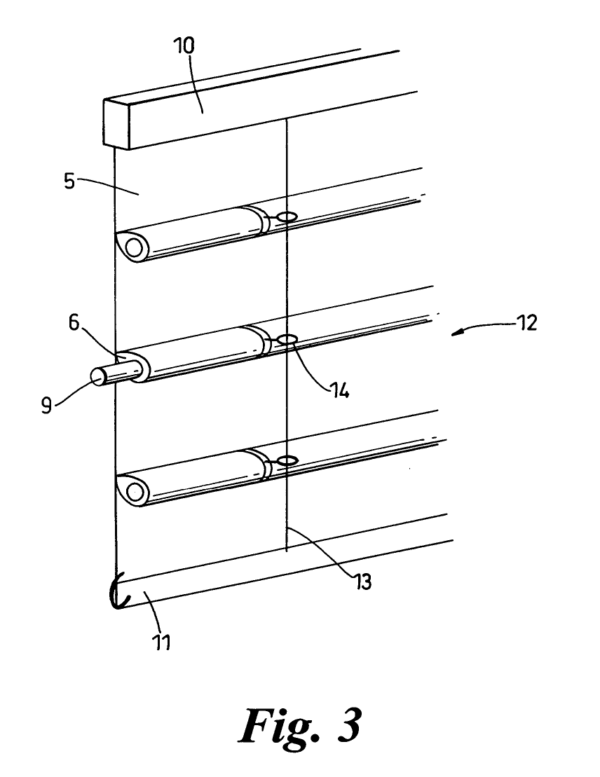

The Roman blind fabric 5 is attached, as shown in FIG. 3, at a first end to a conventional Roman blind head rail 10 and at a second end to a lifting bar 11 to provide a Roman blind 12 (FIG. 3). The scaffold elements 9 comprise rods of a conventionally used UV stabilised plastics material and each of the plurality of channels 8 have a scaffold element 9 located therein. The Roman blind 12 includes a plurality of lifting cords 13 extending between the head rail 10 and lifting bar 11. The lifting cords 13 are threaded through a plurality of respective guide elements 14, whereby each lifting cord 13 is guided by a respective vertical array of the guide elements 14.

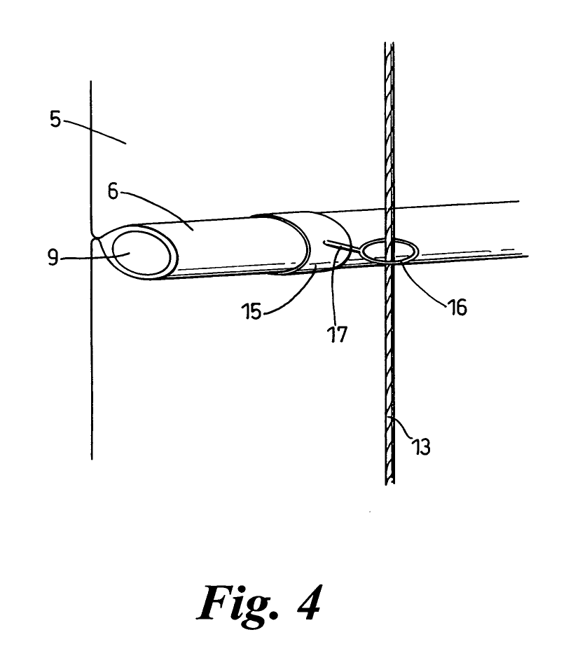

In the present embodiment of this invention the guide elements 14 comprise resiliently deformable snap-fit clips 15 having a C-shaped cross section and including a projecting ‘eye’ portion 16, through which a respective lifting cord 13 is threaded. The eye portion 16 extends from the clip element 15 via an arm 17 (FIG. 4). The guide elements 14 clip over a portion of a respective plastics rod 9, thereby trapping a portion of the blind fabric 5 between the clip 15 and the plastics rod 9. As the guide elements 14 are releasably secured to the blind fabric 5 they may be positioned or re-positioned at any desired point along the length of the rod 9, i.e. at any point across the width of the blind fabric 5.

The remaining components of the Roman blind, such as the headrail 10 are conventional in their construction and arrangement and therefore will not be discussed in more detail herein.

From the above it will be evident that raising the lifting cords 13 will raise the lifting bar 11 until it makes contact with the first scaffold element 9. Further raising of the lifting cords 13 will raise both the lifting bar 11 and each subsequent scaffold element 9 until the lifting bar 11 and each of the scaffold elements 9 are grouped together at the headrail 10.

It will be apparent to those skilled in the art that various modifications could be made to the specific embodiment described above within the scope of the present invention as defined in the appended claims.

1. A Roman blind fabric comprising a non-woven web of continuous filaments or microfilaments, the web having a weight in the range 5 g/m²-600 g/m² and being formed from composite filaments, the fabric including a plurality of elongate widthwise channels adapted to receive therein respective scaffold elements.

2. A Roman blind fabric according to claim 1, wherein the channels are formed from shaped portions of the fabric.

3. A Roman blind fabric according to claim 1, wherein the channels are formed as separate elements which are attached to the fabric.

4. A Roman blind fabric according to claim 1, wherein the channels are equally vertically spaced.

5. A Roman blind fabric according to claim 1, wherein the channels extend across substantially the entire width of the fabric.

6. A Roman blind fabric according to claim 1 wherein the composite filaments are a polyester/polyamide composite.

7. A Roman blind fabric according to claim 1 wherein the web has a weight in the range 150-190 g/m².

8. A method of forming a Roman blind fabric, the method comprising:
(a) providing a non-woven web of continuous filaments or microfilaments, the web having a weight in the range 5 g/m²-600 g/m² and being formed from composite filaments;
(b) shaping the non-woven web to form a plurality of elongate widthwise channels; and
(c) securing each channel in place by either stitching or bonding the fabric adjacent to the channel.

9. A method of forming a Roman blind fabric, the method comprising:
(a) providing a non-woven web of continuous filaments or microfilaments, the web having a weight in the range 5 g/m²-600 g/m² and being formed from composite filaments;
(b) separately providing a plurality of channel forming elements; and
(c) securing the channel forming elements to the fabric.

10. A Roman blind comprising a headrail, a lifting bar and located therebetween a Roman blind fabric according to claim 1, wherein the Roman blind fabric includes a scaffold element located in each channel.

11. A Roman blind according to claim 10, further comprising one or more vertical arrays of guide elements, wherein each guide element is secured to the Roman blind fabric and each vertical array guides a respective lifting cord extending from the headrail to the lifting bar.

12. A Roman blind according to claim 11, wherein the guide elements are secured to the Roman blind fabric by trapping a portion of the fabric between the guide element and a respective scaffold element.
